(19) United States
(12) Patent Application Publication
(10) Pub. No.: US 2015/0281699 A1
(43) Pub. Date: Oct. 1, 2015

(54) INFORMATION PROCESSING DEVICE AND METHOD

(71) Applicant: FUJITSU LIMITED, Kawasaki-shi (JP)

(72) Inventors: Ryo MIYAMOTO, Kawasaki (JP); Tomoharu IMAI, Kawasaki (JP); Koichi YAMASAKI, Kawasaki (JP); Kenichi HORIO, Yokohama (JP); Kazuki MATSUI, Kawasaki (JP)

(73) Assignee: FUJITSU LIMITED, Kawasaki-shi (JP)

(21) Appl. No.: 14/564,294

(22) Filed: Dec. 9, 2014

(30) Foreign Application Priority Data
Mar. 28, 2014 (JP) 2014-070538

(51) Int. Cl. H04N 19/172

(52) U.S. Cl. CPC H04N 19/172

(57) ABSTRACT

An information processing device includes a processor; and a memory which stores a plurality of instructions, which when executed by the processor, cause the processor to execute: transmitting a created image to a client terminal; acquiring at least one image created at timing different from image transmission timing by the transmitting; and calculating a change frequency, based on the transmitted image by the transmitting and the image acquired by the acquiring, for each of multiple divided areas constituting an image.

### CROSS-REFERENCE TO RELATED APPLICATION

This application is based upon and claims the benefit of priority of the prior Japanese Patent Application No. 2014-070538 filed on Mar. 28, 2014, the entire contents of which are incorporated herein by reference.

### FIELD

Embodiments discussed herein are related to an information processing device, a change detection method, and a change detection program, for example.

### BACKGROUND

A virtual desktop which is a client desktop virtualized on a server has been conventionally known. For this virtual desktop, a server establishes thereon an environment in which a client is virtualized, receives a remote operation from a client, and transmits images of a desktop screen to the client at a predetermined frame rate to cause the client to display the image.

In this regard, if the server transmits all the images of the desktop in the form of still image data, a data amount of the image data transmitted through a network is increased so much that operability on the client side may deteriorate. For example, if a communication bandwidth of a network between the server and the client is narrow, an increase in the amount of data transmitted may cause a delay in displaying the image on the client side and deteriorate the operability.

To address this problem, as a technique of reducing the amount of data transmitted, there has been a technique of: dividing an image in a frame to be transmitted into multiple areas; determining a frequency of change between the images in frames for each of the divided areas; performs moving image compression processing on the data of the area whose change frequency exceeds a threshold; and then transmits the compressed data. The technical documents related to such a technique include Japanese Laid-open Patent Publication Nos. 2011-238014, 2012-14533, 2004-213418, and the like.

### SUMMARY

In accordance with an aspect of the embodiments, an information processing device includes a processor; and a memory which stores a plurality of instructions, which when executed by the processor, cause the processor to execute: transmitting a created image to a client terminal; acquiring at least one image created at timing different from image transmission timing by the transmitting; and calculating a change frequency, based on the transmitted image by the transmitting and the image acquired by the acquiring, for each of multiple divided areas constituting an image.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

These and/or other aspects and advantages will become apparent and more readily appreciated from the following description of the embodiments, taken in conjunction with the accompanying drawing of which:

FIG. 1 is a diagram illustrating an example schematic configuration of an entire system according to a first embodiment;

FIG. 2 is a diagram illustrating an example functional configuration of a server according to the first embodiment;

FIG. 3 is a diagram for illustrating divided areas in which an image is divided;

FIG. 4A is a diagram for illustrating a point of determining a change frequency of a desktop screen;

FIG. 4B is a diagram for illustrating a point of determining a change frequency of a desktop screen;

FIG. 5A is a diagram for illustrating a point of correcting a connected area;

FIG. 5B is a diagram for illustrating a point of correcting a connected area;

FIG. 5C is a diagram for illustrating a point of correcting a connected area;

FIG. 6 is a diagram illustrating an example functional configuration of a terminal;

FIG. 7 is a diagram schematically illustrating an example flow of detecting a frequently updated area according to the first embodiment;

FIG. 8 is a diagram schematically illustrating an example flow of an operation of calculating a change frequency according to the first embodiment;

FIG. 9 is a diagram schematically illustrating an example flow of detecting a frequently updated area with only an image in a transmission frame;

FIG. 10 is a diagram schematically illustrating other example flow of detecting a frequently updated area according to the first embodiment;

FIG. 11 is a flowchart illustrating an example procedure of change detection processing according to the first embodiment;

FIG. 12 is a diagram schematically illustrating an example flow of an operation of calculating a change frequency according to a second embodiment;

FIG. 13 is a diagram illustrating an example functional configuration of a server according to a third embodiment;

FIG. 14 is a diagram illustrating an example of a speed-specific setting information table;

FIG. 15 is a diagram schematically illustrating an example flow of detecting a frequently updated area;

FIG. 16 is a diagram schematically illustrating an example flow of detecting a frequently updated area;

FIG. 17 is a flowchart illustrating an example procedure of setting update processing according to the third embodiment; and

FIG. 18 is a diagram illustrating a computer executing a change detection program.

### DESCRIPTION OF EMBODIMENTS

Hereinafter, described based on the drawings are embodiments of an information processing device, a change detection method, and a change detection program according to the present disclosure. It is to be noted that the embodiments are not intended to limit the disclosure, and each of the embodiments may be properly combined within a scope in which the contents of processing do not become inconsistent.

[System Configuration]

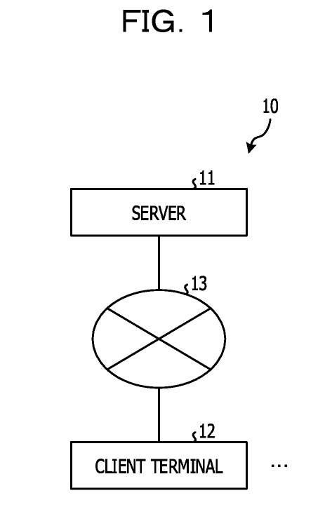

A system 10 according to a first embodiment is described. FIG. 1 is a diagram illustrating an example schematic configuration of an entire system according to the first embodiment. As illustrated in FIG. 1, the system 10 is a system to virtualize a client's desktop on a server. The system 10 has a server 11 and a client terminal 12. The server 11 and the client terminal 12 are caused to be capable of exchanging various pieces of information. For example, the server 11 and the client terminal 12 are communicably connected with each other through a network 13, so that various pieces of information may be exchanged with each other. As an aspect of the network 13, regardless of wired or wireless, any kinds of communication networks may be adopted, such as a mobile communication, including a mobile telephone, the Internet, a local area network (LAN), and a virtual private network (VPN).

The server 11 is a device to provide a virtual desktop in which a client's desktop is virtualized. For example, the server 11 is a computer like a server computer. The server 11 accepts an information processing device. The server 11 may be implemented as one computer or may be implemented as a cloud including multiple computers. It is to be noted that the embodiment describes an example in which the server 11 is assumed as one computer. The server 11 has an established client's virtualized environment and remotely accepts an operation from the client. For example, the server 11 periodically transmits an image of a client's virtualized desktop screen to the client and remotely accepts an operation from the client. The server 11 has an installed or preinstalled application for remote screen control for a server to establish a virtual environment in which a client is virtualized. It is to be noted that the application for remote screen control for a server is referred to as a server side remote screen control application.

The server side remote screen control application has a function to provide remote screen control services as a basic function. As one example, the server side remote screen control application accepts an operation from the client terminal 12 and causes an application operating therein to perform processing desired by the accepted operation. Then, after an image to display a result of the processing executed by the application is created, the server side remote screen control application transmits the created screen to the client terminal 12. At this time, the server side remote screen control application transmits an image of an updated area which is an area where gathers pixels of a portion changed as compared with an image having been transmitted to the client terminal 12 before the image is created this time and displayed. It is to be noted that the description is given to a case where an image of the updated portion is formed in a rectangular image, but the disclosed device may be used to a case where an image of the updated portion is formed in a shape other than a rectangle.

In addition, the server side remote screen control application has a function to compress data of a portion where there is a large movement between frames by a compression scheme suitable for moving images, and to transmit the compressed data to the client terminal 12. As one example, the server side remote screen control application divides the image created from the result of the determination executed by the application into multiple areas, and detects a change frequency for each of the divided areas. At this time, the server side remote screen control application transmits attribute information of an area whose change frequency is equal to or larger than a threshold, namely, a frequently updated area to the client terminal 12. Along with this, the server side remote screen control application transmits the image in the frequently updated area to the client terminal 12 after encoding the data in a Moving Picture Experts Group (MPEG) scheme, such as MPEG-2 or MPEG-4. It is to be noted that the case where the data is compressed to the MPEG scheme is illustrated, but the compression scheme is not limited to this. For example, any compression encoding scheme, such as Motion-Joint Photographic Experts Group (JPEG) as long as it is a compression method for moving images.

The client terminal 12 is a computer which is used by a user. For example, the client terminal 12 may be an information processing device such as a desktop personal computer (PC) or a laptop PC. For example, the client terminal 12 may also be a mobile terminal device such as a tablet terminal, a smartphone, or a personal digital assistant (PDA). For example, the client terminal 12 may also be a thin client. The thin client is a terminal device which includes minimum input and output devices. For example, the thin client does not include a hard disk, and resources thereof are unitarily managed on a server side. It is to be noted that in the example of FIG. 1, a case where the number of client terminals 12 is one is illustrated, but the disclosed system is not limited to this. The number of client terminals 12 may be any number.

The client terminal 12 receives remote screen control services provided by the server 11. In the client terminal 12, a remote screen control application for clients who are recipients of the remote screen control services is installed or preinstalled. It is to be noted that the remote screen control application for clients is hereinafter referred to as a client side remote screen control application.

This client side remote screen control application has a function to notify the server 11 of operation information accepted through various kinds of input devices such as a mouse and a keyboard. As one example, the client side remote screen control application notifies a position, a movement amount, and the like of a mouse cursor obtained through right and left clicks, a double click, or a drag of a mouse, and an operation of moving a mouse, as operation information. As another example, a rotation amount of a mouse wheel, a type of a key pressed down among the keyboard are also notified as the operation information.

Furthermore, the client side remote screen control application has a function to display an image received from the server 11 in a predetermined display unit. As one example, the client side remote screen control application receives an image of an updated area from the server 11. When the image of the updated area is received, the client side remote screen control application displays the image of the updated area aligned in a position which is changed from the previous image. As another example, the client side remote screen control application receives attribution information of a frequently updated area and compression method data for moving images from the server 11. When the attribution information and the compression method data for moving images are received, the client side remote screen control application displays an image in which the compression method data for moving images is decoded in a composite manner in an area on the display screen corresponding to the position included in the attribute information.

The system 10 causes an application relating to work of a client to execute on a virtual desktop and displays a result of processing of the application in the client terminal 12, so as to provide various services. For example, the system 10 causes an application relating to work such as document or email creation to operate on the virtual desktop of the server 11 and remotely provides a document creation environment on the virtual desktop. In addition to these work applications, for example, the system 10 causes a computer aided design (CAD) program to operate on the virtual desktop of the server 11 and remotely provides a design environment on the virtual desktop.

[Server Configuration]

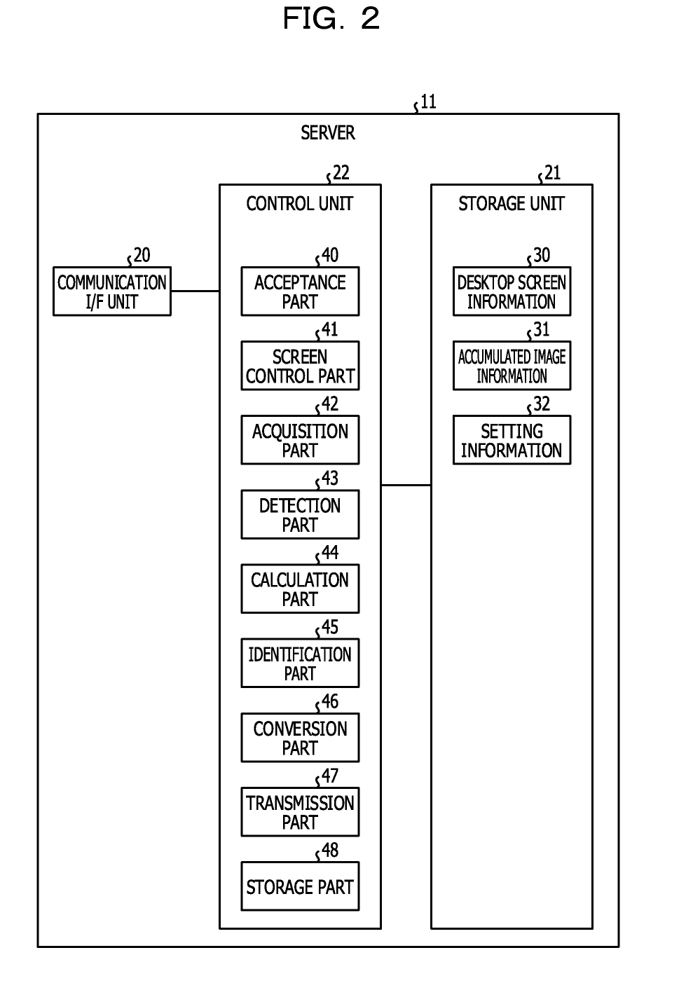

Next, the server 11 according to the first embodiment is described. FIG. 2 is a diagram illustrating an example functional configuration of the server according to the first embodiment. As illustrated in FIG. 2, the server 11 has a communication interface (I/F) unit 20, a storage unit 21, and a control unit 22.

The communication I/F unit 20 is an interface to perform communication control with other devices. The communication I/F unit 20 transmits and receives various pieces of information with other devices through the network 13. For example, the communication unit I/F unit 20 receives the operation information for the virtualized desktop from the client terminal 12. Also, the communication I/F unit 20 transmits data relating to the desktop screen to be displayed in the client terminal 12 to the client terminal 12. The communication I/F unit 20 may adopt a network interface card such as a LAN card.

The storage unit 21 is a storage device to store various pieces of data. One aspect of the storage unit 21 includes a semiconductor memory element such as a flash memory and a storage device such as a hard disk or an optical disk. It is to be noted that the storage unit 21 is not limited to the above-described kinds of storage devices, but may be a random access memory (RAM). Also, the storage unit 21 may be physically divided into multiple storage devices.

The storage unit 21 stores an operating system (OS) and a various kinds of programs which are executed by the control unit 22. For example, the storage unit 21 stores a program of the server side remote screen control application. Furthermore, the storage unit 21 stores various pieces of data which are used by the program to be executed by the control unit 22. For example, the storage unit 21 stores desktop screen information 30, accumulated image information 31, and setting information 32.

The desktop screen information 30 is data in which an image of the virtual desktop screen of the client terminal 12 is stored. The desktop screen information 30 stores image data of the created latest desktop screen of the client terminal 12, and is updated as appropriate when rewrite is caused on the desktop screen. For example, the desktop screen information 30 is updated when rewrite is caused on the desktop screen by the operation accepted from the client terminal 12, the OS, or the processing of the executing program.

The accumulated image information 31 is data in which an image of the desktop screen at predetermined timing is stored. For example, the accumulated image information 31 stores an image in a transmission frame transmitted to the client terminal 12 and a desktop image between the transmission frames for a predetermined period of time.

The setting information 32 is data in which various settings relating to the remote screen control services are stored. For example, the setting information 32 stores a frame rate in which the image of the desktop screen is transmitted to the client terminal 12, a threshold which is used for determining a frequently updated area, the number of pages of the desktop screen to be acquired between the transmission frames, and the like.

It is to be noted that the desktop screen information 30, the accumulated image information 31, and the setting information 32 may be separately stored in multiple storage devices. For example, the desktop screen information 30 may be stored in a video memory, the accumulated image information 31 may be stored in a main memory, and the setting information 32 may be stored in a hard disk.

The control unit 22 is a device to control the server 11. The control unit 22 may adopt an electronic circuit such as a central processing unit (CPU) or a micro processing unit (MPU), or an integrated circuit such as an application specific integrated circuit (ASIC), or a field programmable gate array (FPGA). The control unit 22 has an internal memory to store programs and control data which define various kinds of processing procedures and executes the various kinds of processing therewith. The control unit 22 has various kinds of programs operating therein and functions as various kinds of processing units. For example, in the control unit 22, the server side remote screen control application operates. The control unit 22 has an acceptance part 40, a screen control part 41, an acquisition part 42, a detection part 43, a calculation part 44, an identification part 45, a conversion part 46, a transmission part 47, and a storage part 48.

The acceptance part 40 is a processing part to accept an operation with respect to a virtual environment of the client terminal 12. For example, the acceptance part 40 accepts operation information with respect to the virtual desktop screen from the client terminal 12 as an operation for the virtual environment.

The screen control part 41 is a processing part to control update of the virtual desktop screen. For example, when operation information is accepted by the acceptance part 40, the screen control part 41 performs update to rewrite the desktop screen information 30 according to the accepted operation information. It is to be noted the screen control part 41 may directly perform the update on the desktop screen information 30. Also, the update of the desktop screen information 30 may be performed through an OS or a graphic driver. For example, the screen control part 41 may notify the OS of the accepted operation information, the OS may perform drawing request according to the notified operation information on the graphic driver, and then the graphic driver may update the desktop screen information 30 according to the drawing request.

The acquisition part 42 is a processing part to acquire image data of the desktop screen at predetermined timing. The acquisition part 42 reads the desktop screen information 30 stored in the storage unit 21 at predetermined timing and acquires the image data of the desktop screen. For example, the acquisition part 42 acquires the image data of the desktop screen at transmission timing in which the image is transmitted to the client terminal 12 according to a transmission frame rate stored in the setting information 32. Also, the acquisition part 42 acquires the image data of the desktop screen at timing during the transmission timing. For example, the acquisition part 42 obtains timing so that the number of pages to be acquired, which is stored in the setting information 32, is obtained during each of the transmission frame rates, and acquires the image data of the desktop screen at the obtained timing. For example, when it is designated that the number of pages to be acquired is 2, the acquisition part 42 obtains timing to equally divide a time period during the transmission timing into 3, and acquires the image data of the desktop screen at each of the divided timing. Accordingly, for example, when it is designated that the transmission frame rate is 24 pages per second and the number of pages to be acquired is 2, the acquisition part 42 periodically acquires an image at the transmission frame rate of 72 pages per second. It is to be noted that the timing to acquire the image data of the desktop screen during a time period during the transmission timing typically does not have to be equal.

The detection part 43 is a processing part to detect an updated area which is changed in the images transmitted to the client terminal 12. The detection part 43 detects an updated area by comparing an image to be transmitted to the client terminal 12 with an image having been transmitted before the image to be transmitted. For example, in a case where the image data of the desktop screen is acquired by the acquisition part 42 when the timing reaches the transmission timing, the detection part 43 reads an image in the previously transmitted transmission frame from the accumulated image information 31. Then, the detection part 43 compares the image of the image data acquired by the acquisition part 42 with the image in the previously read transmission frame from the accumulated image information 31. Then, the detection part 43 forms pixels of a portion which is changed in the image in the previous transmission frame after the pixels are gathered in a rectangular shape and specifies the updated area in which the image is changed. The detection part 43 creates position information indicating a position inside the image of the specified updated area. For example, the detection part 43 creates coordinates of a specific vertex such as upper left vertex of the rectangular updated area within the image and a width and height of the updated area as position information.

The calculation part 44 is a processing unit to calculate a change frequency of each of areas of an image. For example, the calculation part 44 calculates a change frequency for each of divided areas of the image, which are divided in a mesh form.

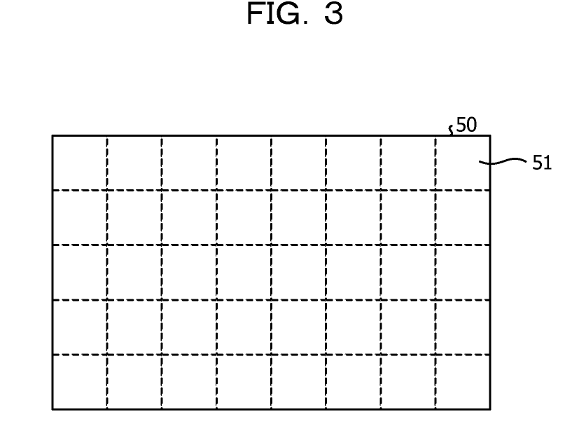

FIG. 3 is a diagram illustrating divided areas in which an image is divided. As illustrated in FIG. 3, an image 50 is divided into multiple divided areas 51. In the example of FIG. 3, the image 50 is divided into the divided areas 51 in a mesh form with 5-by-8 in height and width. It is to be noted that the numbers of dividing an image in height and width are an example and are not limited to this.

The calculation part 44 compares the images accumulated in the accumulated image information 31 and counts the number of changes, as a change frequency of the divided area, for each of the divided areas of the updated area detected by the detection part 43. For example, the calculation part 44 reads the images one after another for a predetermined period of time, which are accumulated in the accumulated image information 31, and compares the updated areas detected by the detection part 43 between the images, and specify a pixel with a changed pixel value within the updated area. Then, when the image with a changed pixel value is included within the divided area, the calculation part 44 adds the number of changes of the divided area by 1 for each of the divided areas. It is to be noted that it may be designed that the calculation part 44 counts the number of changes when the predetermined or more number of the pixels with a changed pixel value are included within the divided area.

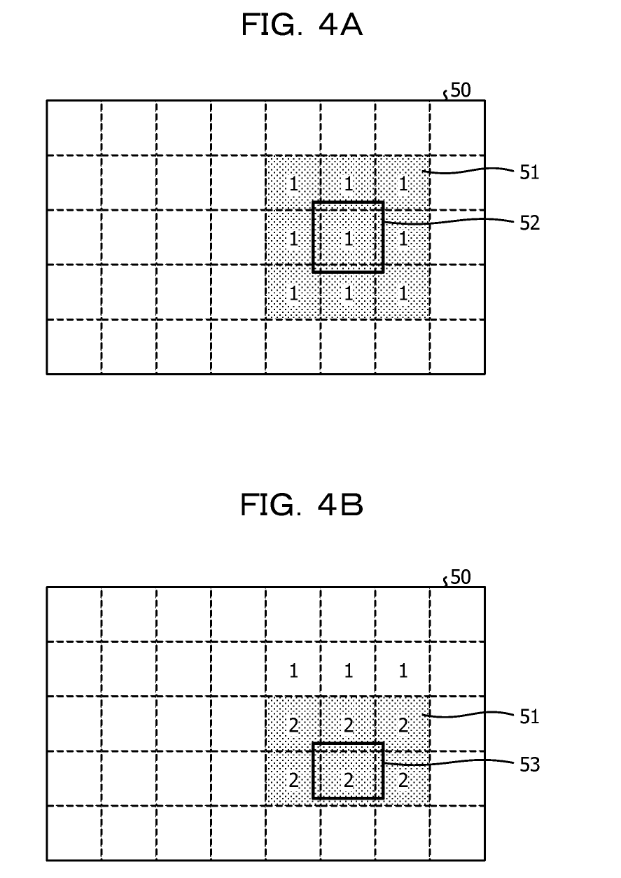

FIGS. 4A and 4B are diagram, each illustrating a point of determining a change frequency of the desktop screen. FIGS. 4A and 4B illustrates an example in which the image 50 is divided into the divided areas 51 with 5-by-8 in height and width and the number of changes is counted. The example of FIG. 4A illustrates a case where a pixel of an updated area 52 is changed. In this case, the calculation part 44 counts up the number of changes to 1 in the divided area 51 in a hatching portion with which the updated area 52 overlaps. The example of FIG. 4B illustrates a case where a pixel of an updated area 53 is further changed. When the pixel of the updated area 53 is further changed, the calculation part 44 adds 1 to the number of changes in the divided area 51 including the updated area 53. In this case, the divided area 51 in the hatching portion originally has 1 as the number of changes, and thus the number of changes becomes 2 by adding 1. It is to be noted that it is assumed that the divided area 51 to which a number is not illustrated, has 0 as the number of changes.

The identification part 45 is a processing part to identify an area with a high change frequency in the desktop screen displayed on the client terminal 12. For example, when counting the number of changes by the calculation part 44 is terminated, the identification part 45 specifies a divided area in which the number of changes, that is, the change frequency, in a predetermined period of time is a threshold or larger number stored in the setting information 32. For example, when it is assumed that the threshold is “2”, in the example of FIG. 4B, the divided area 51 in the hatching area is specified. As a value of such a threshold is set higher, a portion with a higher possibility of displaying a moving image on the desktop screen may be encoded with the conversion part 46 to be described later. It is to be noted that as for the “threshold”, a developer of the server side remote screen control application may cause an end user to select a value set in stages or an end user to directly set a value.

When the divided area whose number of changes is equal to or larger than the threshold, the identification part 45 connects the divided areas adjacent to each other among the specified divided areas and correct them into a connected area. As one example, the identification part 45 connects the divided areas sharing the same sides, that is, the divided areas vertically and horizontally adjacent to each within the screen and corrects them into a connected area.

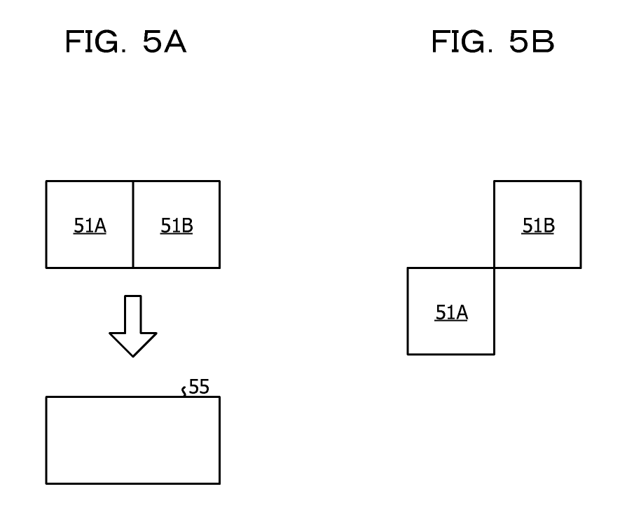

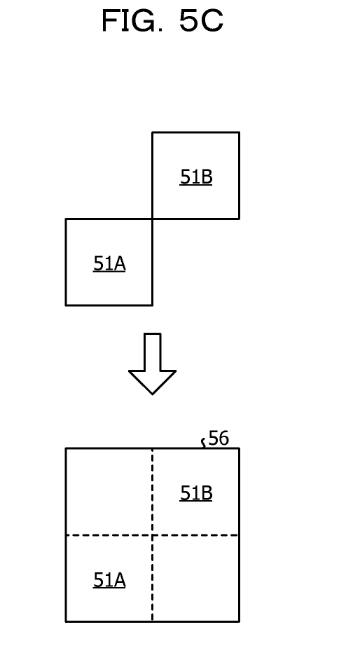

FIGS. 5A to 5C are diagrams, each for illustrating a point of correcting a connected area. As illustrated in FIG. 5A, when two divided areas 51A, 51B are adjacent to each other horizontally, the identification part 45 connects the divided areas 51A, 51B with each other and corrects them into a rectangular connected area 55. On the other hand, as illustrated in FIG. 5B, when two divided areas 51A, 51B are diagonally adjacent to each other, the identification part 45 does not connect the divided areas 51A, 51B. It is to be noted that described in the embodiment is the case where the divided areas vertically and horizontally adjacent to each other are connected and corrected to a connected area, but the embodiment is not limited to this. For example, when there are multiple divided areas whose distance or the like meets a predetermined condition, the identification part 45 may derive an interpolated area to interpolate an area and then add the divided area whose number of changes is equal to or larger than the threshold and the interpolated area, so that a connected area including the divided area whose number of changes is equal to or larger than the threshold is obtained. It is assumed that the distance between the areas is the shortest distance between the areas. Also, for example, the identification part 45 may obtain a connected area so as to include the divided area whose number of changes is equal to or larger than the threshold. As illustrated in FIG. 5C, when the two divided areas 51A, 51B are diagonally adjacent to each other, the identification part 45 may obtain a rectangular connected area 56 in which the divided areas 51A, 51B are inscribed.

Return to FIG. 2. The identification part 45 identifies a connected area as a frequently updated area with a high change frequency. It is to be noted that when there are multiple connected areas, the identification part 45 may identify each of the connected areas as a frequently updated area. Also, when there are multiple connected areas, the identification part 45 may identify a connected area with a predetermined size or larger, or a connected area with the largest size as a frequently updated area. Also, when there are multiple connected areas, the identification part 45 may derive an interpolated area to interpolate an area between the connected areas and then identify an area in which the connected area and the interpolated area are added to each other as a frequently updated area.

The conversion part 46 is a processing part to perform conversion on image data of the desktop screen. For example, the conversion part 46 converts the image in a portion of the frequently updated area of the image data of the desktop screen, which is acquired by the acquisition unit 42 at transmission timing, into data in the moving image format. As one example, the conversion part 46 encodes a bitmap image in the frequently updated area at the stage in which the desktop screen acquired by the acquisition part 42 reaches the number of frames capable of forming a stream. It is to be noted that one aspect of the encoding method includes an MPEG method such as MPEG-2 or MPEG-4 or Motion-JPEG method.

The conversion part 46 converts an image in the portion of the updated area of the image data of the desktop screen acquired by the acquisition unit 42 at the transmission timing into data in a still image format. When the frequently updated area is identified and the updated area includes a portion other than the frequently updated area, the conversion part 46 converts an image of the portion other than the frequently updated area of the updated area of the desktop screen into data in a still image format. For example, the conversion part 46 divides the image in a portion of the updated area of the desktop screen, which is other than the frequently updated area, into multiple rectangular portions, and converts the data into image data for each of the rectangular portions. In other words, when the updated area of the desktop screen includes the portion other than the frequently updated area, the conversion part 46 divides the image of the portion of the updated area excluding the frequently updated area into the images of the multiple rectangular portions so as to display the images in combination. The conversion part 46 also creates arrangement information indicating an arrangement relationship in the rectangular image. In the embodiment, even when the updated area does not include the frequently updated area, arrangement information in which an image to be arranged in the updated area is corresponded. It is to be noted that the conversion part 46 may convert the portion of the frequently updated area in the updated area of the desktop screen into image data as blank or a transparent area.

The transmission part 47 is a processing part to perform transmission of data to the client terminal 12. For example, the transmission part 47 is a processing part to perform transmission of data relating the desktop screen to the client terminal 12. For example, the transmission part 47 transmits the position information of the updated area, the image data of the image of the frequently updated area portion of the desktop screen, and the arrangement information. Also, when the desktop screen includes the frequently updated area, the transmission part 47 further transmits moving image data of the portion of the frequently updated area and attribution information indicating the position and size of the frequently updated area inside the image. Accordingly, the client terminal 12 obtains the position of the updated area in the image based on the position information and restores the desktop screen by arranging the image based on the arrangement information. Also, the client terminal 12 displays the image of the moving image data in a composite manner in the portion of the frequently updated area of the desktop screen based on the attribution information.

The storage part 48 is a processing part to store the image data of the desktop screen, which is acquired by the acquisition part 42. For example, the storage part 48 stores the image data of the desktop screen, which is acquired by the acquisition part 42 in the accumulated image information 31. In this case, the storage part 48 stores the image data in the accumulated image information 31 by adding information indicating time such as image acquisition time or the order such as a sequence number and information indicating if it is a transmission frame. Also, the storage part 48 deletes the image data whose predetermined period of time has elapsed from the accumulated image information 31. As described above, the image data of the desktop screen during the last predetermined period of time is accumulated in the accumulated image information 31. The period of accumulating the image data has a correlation with accuracy of identifying the frequently updated area. As the period becomes longer, error detection of the frequently updated area is decreased. It is to be noted that assumed here is a case where the image data of the desktop screen is accumulated during one second.

[Terminal Configuration]

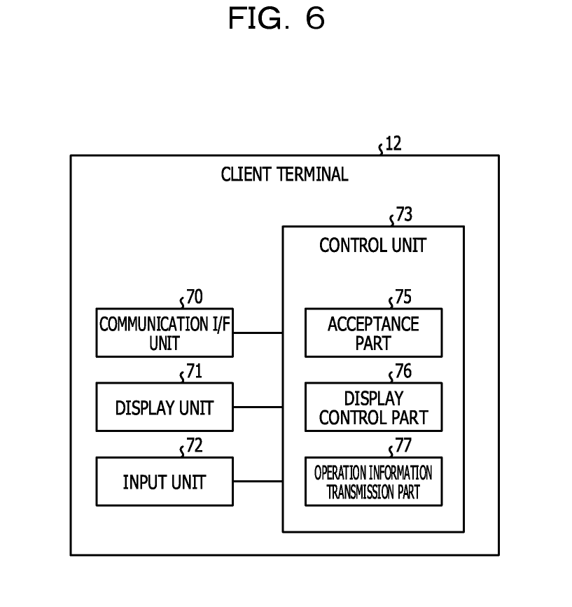

Hereinafter, the terminal according to the first embodiment is described. FIG. 6 is a diagram illustrating an example functional configuration of a terminal. As illustrated in FIG. 6, the client terminal 12 has a communication I/F unit 70, a display unit 71, an input unit 72, and a control unit 73.

The communication I/F unit 70 is an interface to control communications with other devices. The communication I/F unit 70 transmits and receives various pieces of information with other devices through the network 13. For example, the communication I/F unit 70 receives data relating to the desktop screen from the server 11. Also, the communication I/F unit 70 transmits operation information for the desktop to the server 11. The communication I/F unit 70 may adopt a network interface card such as a LAN card.

The display unit 71 is a display device to display various pieces of information. The display device 71 includes a display device such as a liquid crystal display (LCD) or a cathode ray tube (CRT). The display unit 71 displays various pieces of information. For example, the display unit 71 displays the desktop screen of the virtual desktop transmitted from the server 11.

The input unit 72 is an input device to input various pieces of information. For example, the input unit 72 includes an input device such as a mouse or a keyboard. The input unit 72 accepts an operation input from a user and inputs operation information indicating the accepted operation content into the control unit 73. For example, the input unit 72 accepts various kinds of operations by a mouse or a keyboard with respect to the desktop screen.

The control unit 73 is a device to control the client terminal 12. The control unit 73 may adopt an electronic circuit such as CPU or MPU or an integrated circuit such as ASIC or FPGA. The control unit 73 has an internal memory to store programs and control data which define various processing procedures and executes various kinds of processing therewith. Various kinds of programs operate in the control unit 73, and the control unit 73 functions as various kinds of processing units. For example, a client side remote screen control application operates in the control unit 73. The control unit 73 has a reception part 75, a display control part 76, and an operation information transmission unit 77.

The reception part 75 is a processing part to receive data relating to the virtual desktop from the server 11. For example, the reception part 75 receives data relating to the desktop screen from the server 11. For example, the reception part 75 receives position information of an updated area, image data of a screen of a frequently updated area portion of the desktop screen, and arrangement information. Also, when the desktop screen includes the frequently updated area, the reception part 75 further receives moving image data of a portion of the frequently updated area and attribution information indicating a position and size of the frequently updated area in the image.

The display control part 76 is a processing part to control display of an image of the display unit 71. The display control unit 76 causes the display unit 71 to display the desktop screen based on the data relating to the virtual desktop received by the reception part 75. For example, the display control part 76 obtains a position of the updated area in the image based on the position information and restores the desktop screen by arranging the image based on the arrangement information. Accordingly, when the desktop screen includes a frequently updated area, the desktop screen excluding the portion of the frequently updated area is restored. When the moving image data and the attribute information are not received, the display control part 76 causes the display unit 71 to display the image of the restored desktop screen. On the other hand, when the moving image data and the attribute information are received, the display control part 76 composites the moving image of the moving image data on the image of the restored desktop screen and causes the display unit 71 to display it. For example, the display control unit 76 composites the image of the moving image data on the portion of the frequently updated area of the desktop screen and causes the display unit 71 to display the image of the moving image-composite desktop screen.

The operation information transmission part 77 is a processing unit to transmit operation information with respect to the virtual desktop to the server 11. The operation information transmission part 77 transmits operation information by the input unit 72 to the server 11. For example, the operation information transmission part 77 transmits a movement amount of a mouse cursor obtained through right and left clicks, a double click, or a drag of a mouse and an operation of moving a mouse as operation information. As another example, the operation information transmission part 77 transmits a rotation amount of a mouse wheel, a type of a key pressed down among the keyboard as the operation information.

[Operation of System]

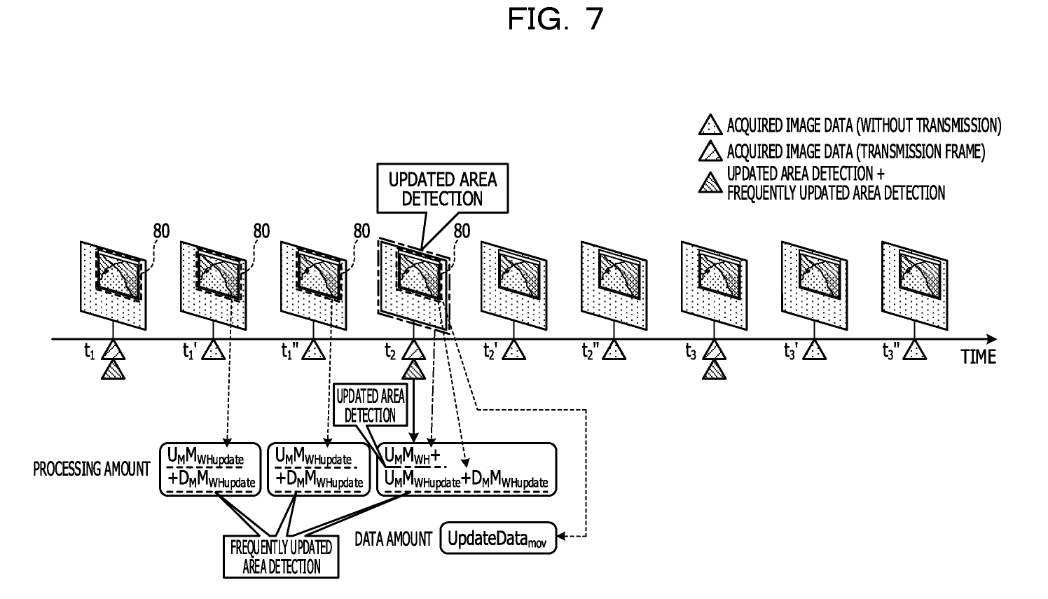

Hereinafter, described is an example operation in which the server 11 detects a frequently updated area from an image of the desktop screen according to the first embodiment. FIG. 7 is a diagram schematically illustrating an example flow of detecting a frequently updated area according to the first embodiment. The example of FIG. 7 illustrates a case where detecting an updated area and detecting a frequently updated area are continuously performed at transmission timing.

FIG. 7 illustrates images of a desktop screen at time points along the time course. The server 11 acquires the image data of the desktop screen from the desktop screen information 30 at transmission timing according to the transmission frame rate and transmits the data relating to the virtual desktop to the client terminal 12. The images at time t₁, t₂, and t₃ are transmission frame images to be transmitted to the client terminal 12.

Also, the server 11 acquires image data of the desktop screen from the desktop screen information 30 even at timing during the transmission timing. In the example of FIG. 7, two images are acquired during the transmission timing. In the example of FIG. 7, image data of the desktop screen is acquired at each of times t₁′, t₁″ between time t₁ and time t₂, times t₂′, t₂″ between time t₂ and time t₃, and times t₃′, t₃″ after time t₃. The images at times t₁′, t₁″, t₂′, t₂″, and t₃′, t₃″ are not transmitted to the client terminal 12.

In the example of FIG. 7, the server 11 detects an updated area which is updated between the images to be transmitted to the client terminal 12 at each of the transmission timing. In the following description, the timing to detect an updated area is referred to as updated area detection timing. In the example of FIG. 7, times t₁, t₂, and t₃ are updated area detection timing. For example, the server 11 detects an updated area by comparing an image to be transmitted with an image having been transmitted one before that image to be transmitted. For example, the server 11 detects an updated area at the timing of time t₂ by comparing an image at time t₂ and an image having been transmitted at time t₁, one image before the image at time t₂. In the example of FIG. 7, as a result of the comparison, an updated area 80 is detected.

Also, in the example of FIG. 7, the server 11 detects an updated area 80 and continuously detects a frequently updated area thereafter. In the following description, the timing of detecting the frequently updated area is referred to as frequently updated area detection timing. In the example of FIG. 7, times t₁′, t₂′, and t₃′ are also frequently updated area detection timing. The server 11 calculates a change frequency by sequentially comparing the updated areas 80 of the images in the descending order in time series from the image at time t₂ when the updated area 80 is detected. In the example of FIG. 7, as a result of the comparison, a change frequency is calculated by sequentially comparing the updated areas 80 of the images in the order of time t₁″, time t₁′, and time t₁ from the image at time t₂ when the updated area 80 is detected.

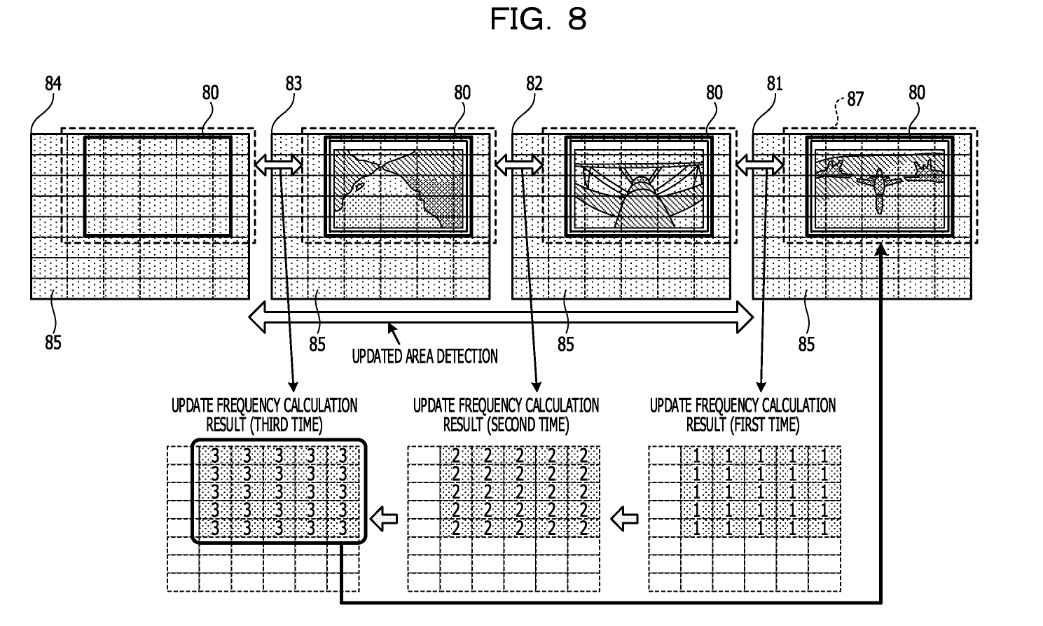

The operation of the server 11 which calculates the change frequency is described more in detail. FIG. 8 is a diagram schematically illustrating an example operation flow of calculating a change frequency according to the first embodiment. In the example of FIG. 8, four images 81 to 84 are sequentially compared with one another in the descending order to calculate a change frequency. For example, the image 81 corresponds to the image at time t₂ in FIG. 7. The image 82 corresponds to the image at time t₁″ in FIG. 7. The image 83 corresponds to the image at time t₁′ in FIG. 7. The image 84 corresponds to the image at time t₁ in FIG. 7. The updated area 80 is detected from the comparison between the image 81 and the image 84.

The server 11 sequentially compares the updated areas of the images 81 to 84 in the descending order in time series and counts up the number of changing the updated area 80 for each of the divided areas. In the example of FIG. 8, as a result of comparing the updated areas 80 of the images 81 and 82, since all the divided areas 85 in the updated area 80 are changed, the number of updates is counted up. Also, as a result of comparing the updated areas 80 of the images 82 and 83, since all the divided areas 85 in the updated area 80 are changed, the number of updates is counted up to 2. Also, as a result of comparing the updated areas 80 of the images 83 and 84, since all the divided areas 85 in the updated area 80 are changed, the number of updates is counted up to 3.

The server 11 specifies a divided area whose number of updates stored in the setting information 32 is equal to or larger than a threshold. For example, when it is assumed that the threshold is “3”, in the example of FIG. 8, the divided areas 85 in the hatching portion illustrated in an area 87 are specified. The server 11 identifies the area 87 as a frequently updated area.

Hereinafter, using an example illustrated in FIG. 7, a processing amount and a transmission data amount, which are estimated for detecting the frequently updated area, are described quantitatively. First, a parameter to be used for estimation is described.

For example, it is assumed that an image of a desktop screen has W as the number of pixels in the width direction and H as the number of pixels in the height direction. Also, an updated area has W_{update} as the number of pixels in the width direction and H_{update} as the number of pixels in the height direction. In this case, a resolution of the entire screen of the desktop screen and a size of the updated area become as follows.
The resolution of the entire screen: W×H
The size of the updated area: W_{update}×H_{update}

Also, a compression rate of a still image and a compression rate of a moving image with respect to the updated area are assumed as follows.
The compression rate of a still image: Imgᵣₐₜₑ
The compression rate of a moving image: Movᵣₐₜₑ

In addition, an update detection processing amount per one divided area and a frequently updated detection processing amount per one divided area are assumed as follows.
The update detection processing amount: U_{M}
The frequent update detection processing amount: D_{M}

In addition, it is assumed that the number of divided areas of an image of the desktop screen in the width direction is M_{W} and the number of divided areas of an image of the desktop screen in the height direction is M_{H}. It is assumed that the number of divided areas of the updated area in the width direction is M_{Wupdate} and the number of divided areas of the updated area in the height direction is M_{Hupdate}. In this case, the number of divided areas M_{WH} in the entire image of the desktop screen and the number of divided areas M_{WHupdate} of the updated area are as follows.
Entire screen: M_{WH}=M_{W}×M_{H}
Updated area: M_{WHupdate}=M_{Hupdate}×M_{Wupdate}

In this case, the update detection processing amount for the entire image of the desktop screen is as following (1). The update detection processing amount for the updated amount is as following (2).

Entire screen: U_{M}×M_{WH}=(U_{M}M_{WH}) (1)

Updated area: U_{M}×M_{WHupdate}=(U_{M}M_{WHupdate}) (2)

Also, the frequently updated area detection processing amount for the entire image of the desktop screen is as following (3). The frequently updated area detection processing amount for the updated area is as following (4).

Entire screen: D_{M}×M_{WH}=(D_{M}M_{WH}) (3)

Updated area: D_{M}×M_{WHupdate}=(D_{M}M_{WHupdate}) (4)

Also, the compression data amount Data_{img} in a still image of the entire image of the desktop screen is as following (5). The compression data amount UpdateData_{img} in a still image of the updated area is as following (6). The compression data amount UpdateDataₘₒᵥ in a moving image of the updated area is as following (7).

Entire screen: Data_{img}=W×H×Imgᵣₐₜₑ (5)

Updated area still image compression: UpdateData_{img}=W_{update}×H_{update}×Imgᵣₐₜₑ (6)

Updated area moving image compression: UpdateDataₘₒᵥ=W_{update}×H_{update}×Movᵣₐₜₑ (7)

It is to be noted that it is assumed in the estimation of the embodiment that a capture time desired for acquiring a screen is sufficiently small and is set to 0.

In this case, when the frequently updated area as illustrated in FIG. 8 is detected at time t₂ in the example of FIG. 7, the updated area 80 is detected once. Also, update detection to detect a change in an image by comparing the updated areas 80 between the images and frequent update detection processing to count the number of changes for each of the divided areas are respectively performed for three times. Accordingly, the processing amount is as following (8) based on the above (1), (2), and (4).

U_{M}M_{WH}+3(U_{M}M_{WHupdate}+D_{M}M_{WHupdate}) (8)

Also, the updated area 80 is transmitted as a moving image at time t₂ in the example of FIG. 7. This data amount is as follows based on the above (7).

UpdateDataₘₒᵥ

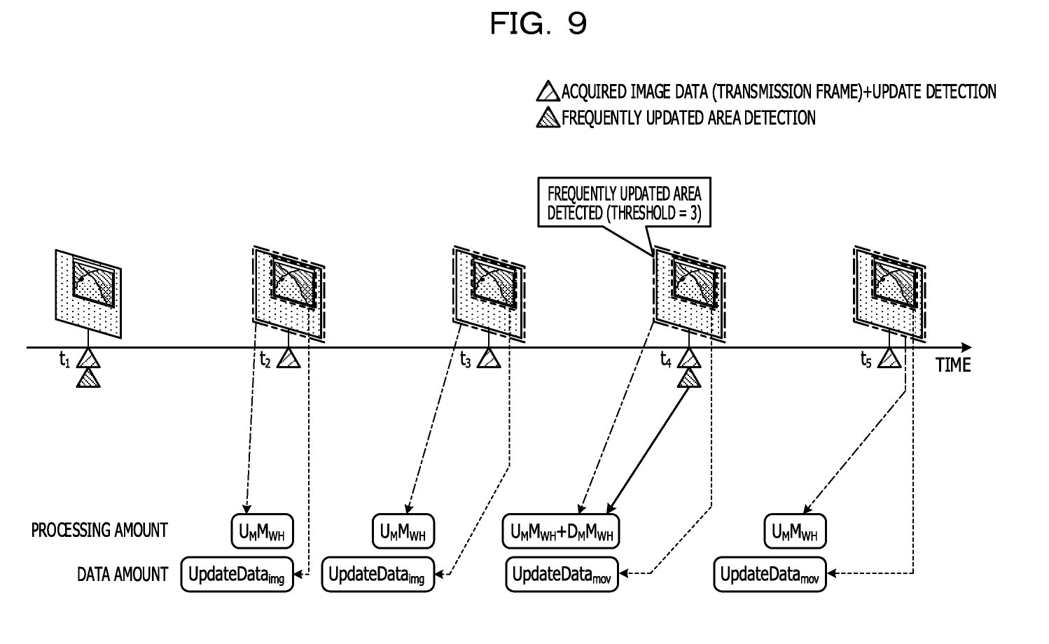

Hereinafter, for example, described for comparison is a case where a frequently updated area is detected only in an image in a transmission frame which is transmitted by the server 11 to the client terminal 12. FIG. 9 is a diagram schematically illustrating an example flow of detecting a frequently updated area only in an image in a transmission frame. The example of FIG. 9 illustrates a case where image data of the desktop screen of the virtual desktop is acquired at the transmission timing corresponding to the transmission frame rate and is transmitted to a client. The images at times t₁ to t₄ are images in the transmission frames to be transmitted to the client. It is assumed in the example of FIG. 9 that a change frequency between images in the transmission frames is determined at each of transmission timing and moving image compression processing is performed on the area whose change frequency exceeds a threshold and the compressed data of the area is transmitted. It is assumed in the example of FIG. 9 that there is no changed position at the time point of the image at time t₁ and the number of changes of all the divided areas is 0, and the number of changes of the screen, as compared with the image one before each of the images at times t₂ to t₄, is counted. The threshold used for determining the frequently updated area is set to “3” as similar to FIGS. 7 and 8. In this case, even when there is a change between an image and an image one before the image at transmission timing of times t₂, t₃, the number of changes of the screen is less than 3. Accordingly, the frequently updated area is not recognized and the entire image is transmitted as a still image. The number of changes of the screen is 3 at the transmission timing at time t₄. Accordingly, the frequently updated area is recognized and the image of the frequently updated area is transmitted as a moving image. It is to be noted that the frequently updated area is assumed to be same as that in the example of FIG. 7.

In this case, the update detection processing is performed on the entire image of the desktop screen at times t₂, t₃. The processing amount is U_{M}M_{WH} based on the above (1). Also, the updated area is transmitted as a still image at times t₂, t₃. This data amount is UpdateData_{img} based on the above (6).

On the other hand, at time t₄, the update detection processing and the frequently updated area detection processing are performed on the entire image of the desktop screen. This processing amount is U_{M}M_{WH}+D_{M}M_{WH} based on the above (1) and (4). Also, the updated area is transmitted as a moving image at time t₄. This data amount is UpdateDataₘₒᵥ based on the above (7).

Here, transfer data amounts in the examples of FIGS. 7 and 9 are compared with each other. In the example of FIG. 7, the frequently updated area is identified at time t₁ and an image of the frequently updated area is transmitted as a moving image. The transmission data amount for this frequently updated area is UpdateDataₘₒᵥ. Also, the transmission data mount for the frequently updated area by time t₃ is 3×UpdateDataₘₒᵥ. On the other hand, in the example of FIG. 9, the frequently updated area is recognized at time t₄ and the image of the frequently updated area is transmitted as a moving image, and thus the transmission data amount for the frequently updated area by time t₄ is 2×UpdateData_{img}+UpdateDataₘₒᵥ. In image transmission of a same area size, the data mount of the image data of the moving image is generally smaller than that of the image data of a still image. Accordingly, the transmission data amount of the example of FIG. 7 is kept smaller.

Also, the processing amounts of the examples of FIGS. 7 and 9 are compared with each other. In the example of FIG. 7, the processing amount when the frequently updated area is identified at time t₂ is U_{M}M_{WH}+3(U_{M}M_{WHupdate}+D_{M}M_{WHupdate}). On the other hand, in the example of FIG. 9, the processing amount when the frequently updated area is identified at time t₄ is U_{M}M_{WH}+D_{M}M_{WH}.

In the embodiment, the frequently updated area is detected by comparing only the updated areas between the images. Accordingly, as the size of the updated area in the image is smaller, the processing amount becomes smaller.

One example to describe a case where a processing amount becomes smaller is estimated.

U_{M}M_{WH}+D_{M}M_{WH}>U_{M}M_{WH}+3(U_{M}M_{WHupdate}+D_{M}M_{WHupdate})

D_{M}M_{WH}>3(U_{M}M_{WHupdate}+D_{M}M_{WHupdate})

Here, for example, it is assumed that W=1,200, H=900, the size of divided areas is 30×30 pixels, UM=5, DM=10, and MWH=40×30 pixels. In this case, the number of divided areas of the updated area M_{WHupdate}≦267 is obtained. For example, when the moving image area is smaller than about 20×13 mesh, the processing amount decreases.

In this manner, the server 11 according to the embodiment calculates a change frequency by sequentially comparing the updated areas of the images. Accordingly, when the number of divided areas of the updated area is small, the server 11 may reduce the processing amount as compared with the case where the change frequency is calculated by sequentially comparing the entire images.

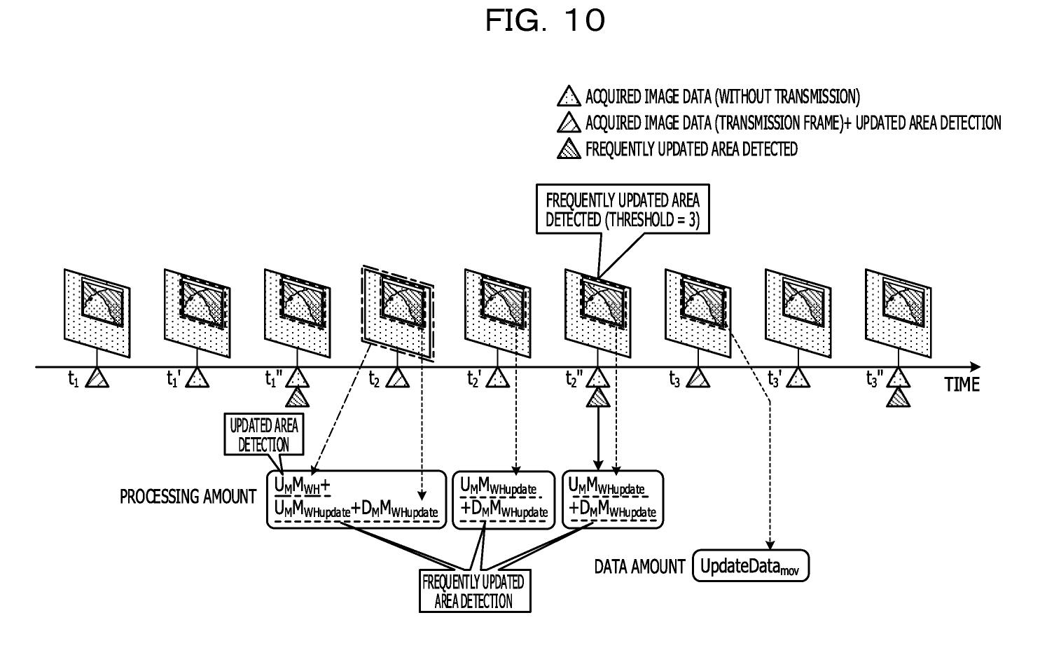

Next, described is another example operation that the server 11 according to the first embodiment detects a frequently updated area from an image of the desktop screen. FIG. 10 is a diagram schematically illustrating another example flow of detecting the frequently updated area according to the first embodiment. The example of FIG. 10 illustrates a case where the updated area is detected at transmission timing and the frequently updated area is detected during the transmission timing.

FIG. 10 illustrates images of the desktop screen at each of time points along the time course. The server 11 acquires image data of the desktop screen from the desktop screen information 30 at transmission timing according to the transmission frame rate and transmits the data relating to the virtual desktop to the client terminal 12. The images at times t₁, t₂, and t₃ are images in transmission frames to be transmitted to the client terminal 12.

Also, the server 11 acquires the image data of the desktop screen from the desktop screen information 30 even at the timing during the transmission timing. In the example of FIG. 10, two images are acquired during the transmission timing. In the example of FIG. 10, image data of the desktop screen is acquired at each of times t₁′, t₁″ between time t₁ and time t₂, times t₂′, t₂″ between time t₂ and time t₃, and times t₃′, t₃″ after time t₃. The images at time t₁′, t₁″, t₂′, t₂″, and t₃′, t₃″ are not transmitted to the client terminal 12.

In the example of FIG. 10, the server 11 detects an updated area which is changed between the images to be transmitted to the client terminal 12 by using each of the transmission timings as the updated area detection timing. In the example of FIG. 10, times t₁, t₂, and t₃ are updated area detection timing. For example, the server 11 detects an updated area by comparing an image to be transmitted with the image having been transmitted one image before that image to be transmitted. For example, the server 11 detects an updated area at the timing of time t₂ by comparing an image at time t₂ and the image having been transmitted at time t₁, one image before the image at time t₂. In the example of FIG. 10, as a result of the comparison, an updated area 80 is detected.

Also, in the example of FIG. 10, the server 11 detects a frequently updated area during the transmission timing. In the example of FIG. 10, the timings of times t₁″, t₂″, and t₃″, the frequently updated area is detected. In the example of FIG. 10, times t₁″, t₂″, and t₃″ are also frequently updated area detection timing. In the example of FIG. 10, as a result of the comparison, a change frequency is calculated by sequentially comparing the updated area 80 of the images in the order of time t₂′, time t₂, and time t₁″, from the image at time t₂″.

In this manner, the server 11 only performs update detection at timings of times t₁, t₂, and t₃, and the processing amount is U_{M}M_{WH}. Also, the server 11 performs detection of frequently updated area at timings of time t₁″, t₂″, and t₃″, and the processing amount is 3(U_{M}M_{WHupdate}+D_{M}M_{wHupdate}).

Since times t₁, t₂, and t₃ are transmission timing, the data relating to the virtual desktop is transmitted to the client terminal 12. Accordingly, the server 11 performs detection of the frequently updated area at other timing, so that a processing load at the transmission timing may be reduced.

[Processing Flow]

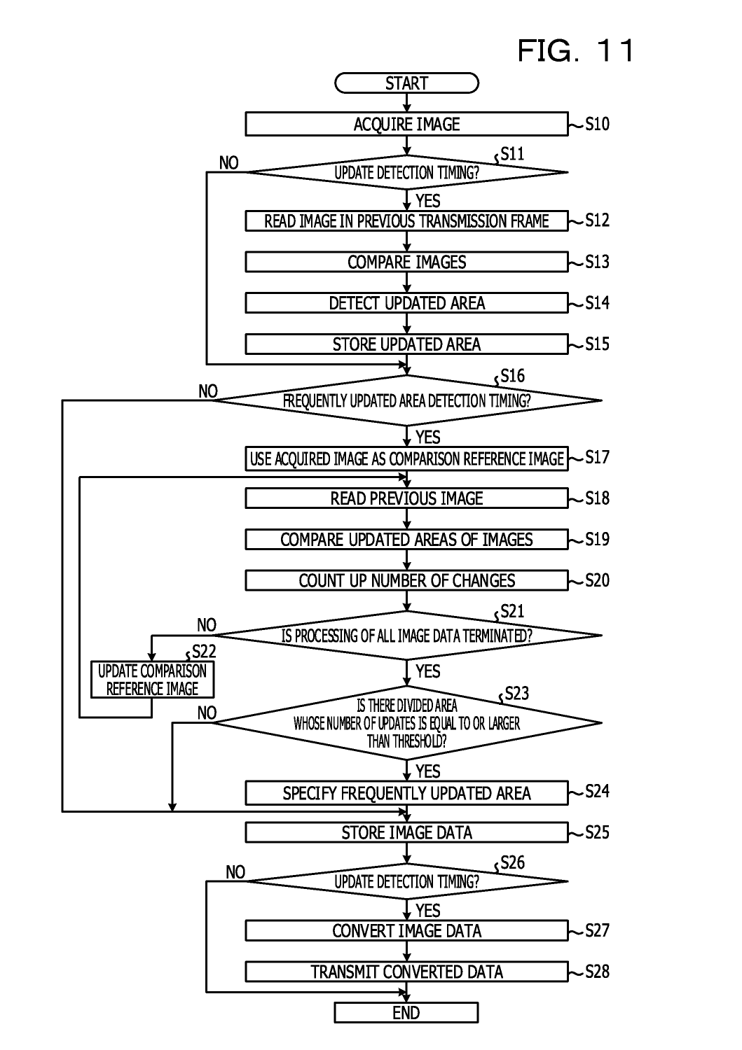

Hereinafter, described is a flow of the change detection processing that the server 11 according to the first embodiment calculates a change frequency and identifies a frequently updated area based on the change frequency. FIG. 11 is a flowchart illustrating an example procedure of the change detection processing according to the first embodiment. This change detection processing is executed at predetermined timing, for example, timing when the acquisition part 42 acquires an image.

As illustrated in FIG. 11, the acquisition part 42 reads the desktop screen information 30 stored in the storage unit 21 and acquires the image data of the desktop screen (S10). The detection part 43 determines if it is update detection timing to detect the updated area (S11). In the examples of FIGS. 7 and 10, times t₁, t₂, and t₃ are updated area detection timing. When it is not the update detection timing (NO at S11), the detection part 43 proceeds to S16 to be described later. On the other hand, when it is the update detection timing (YES at S11), the detection part 43 reads an image of the previously transmitted transmission frame from the accumulated image information 31 (S12). The detection part 43 compares the image acquired at S10 with the image read at S12 (S13). Then, the detection part 43 connects the pixels of the changed portion from the previous transmission frame and forms them into a rectangular shape, and detects an updated area whose image is changed (S14). The detection part 43 temporarily stores the detected updated area in an inner memory for work (S15).

The calculation part 44 determines if it is the frequently updated area detection timing to detect a frequently updated area (S16). In the example of FIG. 7, times t₁, t₂, and t₃ are frequently updated area detection timing. On the other hand, in the example of FIG. 10, times t₁″, t₂″, and t₃″ are frequently updated area detection timing. When it is not the frequently updated area detection timing (NO at S16), the processing proceeds to S25 to be described later. On the other hand, when it is the frequently update detection timing (YES at S16), the calculation part 44 uses the image acquired at S10 as a comparison reference image (S17). The calculation part 44 reads the images one after another from the last one, which are accumulated in the accumulated image information 31 (S18). The calculation part 44 reads the updated area stored in the unillustrated inner memory for work and compares the comparison reference image with the updated area of the image read at S10 (S19). When the divided area includes a pixel whose pixel value is changed for each of the divided areas, the calculation part 44 adds the number of changes of the divided area by 1 (S20). The calculation part 44 determines if reading all the pixels accumulated in the accumulated image information 31 has been completed (S21). When reading all the pixels has not been completed yet (NO at S21), the calculation part 44 updates the image read at S18 with the comparison reference image (S22) and proceeds to S18. Accordingly, the images accumulated in the accumulated image information 31 are sequentially compared with one another.

On the other hand, when reading all the pixels has been completed (YES at S21), the identification part 45 determines if there is a divided area having a change frequency equal to or larger than a threshold stored in the setting information 32 (S23). When there is no divided area having a change frequency equal to or larger than the threshold (NO at S23), the processing proceeds to S25 to be described later. On the other hand, when there is a divided area having a change frequency equal to or larger than a threshold (YES at S23), the identification part 45 specifies the frequently updated area by correcting the divided area whose number of changes is equal to or larger than the threshold (S24).

The storage part 48 stores the image data of the desktop screen acquired at S10 in the accumulated image information 31 (S25).

The conversion part 46 determines if it is the update detection timing to detect an updated area (S26). In the embodiment, in the case of the image transmission timing, it is determined as the update detection timing. When it is not the update detection timing (NO at S26), the processing is terminated. On the other hand, when it is the update detection timing (YES at S26), the conversion part 46 converts the image data of the updated area of the image of the desktop screen acquired at S10 such that the frequently updated area is treated as a moving image area and the other area is treated as a still image area in the updated area (S27). The transmission part 47 transmits the converted image data to the client terminal 12 (S28) and the processing is terminated.

[Effects]

As described above, the server 11 according to the embodiment transmits a created image to the client terminal 12. The server 11 acquires at least one created image at timing different from the image transmission timing. For example, the server 11 acquires at least one image created during the image transmission timing. The server 11 calculates a change frequency for each of multiple divided areas configuring an image from the image having been transmitted and the acquired image. Accordingly, the server 11 may quickly detect an area where a change frequency is high.

Also, the server 11 according to the embodiment compares the image to be transmitted with the image having been transmitted before the image to be transmitted and detects the area where a change is made among the multiple divided areas as an updated area. The server 11 calculates the change frequency by sequentially comparing the updated areas of the image having been transmitted and the acquired image in the descending order in time series from the image in which the updated area is detected. Accordingly, when the size of the updated area is small, the server 11 sequentially compares the entire image and calculates a change frequency, so that the processing amount may be reduced.

In addition, the server 11 according to the embodiment converts the image data of the updated area such that an area whose change frequency is equal to or larger than a predetermined threshold is treated as a moving image area and the other area is treated as a still image area in the updated area. Accordingly, the server 11 may reduce the data amount to be transmitted to the client terminal 12.

### Second Embodiment

Hereinafter, a second embodiment is described. Described in the second embodiment is a case where a comparison is terminated on a divided area whose change frequency is a threshold. The configuration of a server 11 according to the second embodiment is similar to that of FIG. 2, and different portions are mainly described.

A calculation part 44 sequentially compares updated areas of an image, and counts the number of changes as a change frequency for each of divided areas, and terminates the composition on the divided area whose change frequency is a threshold stored in setting information 32.

[Operation of System]

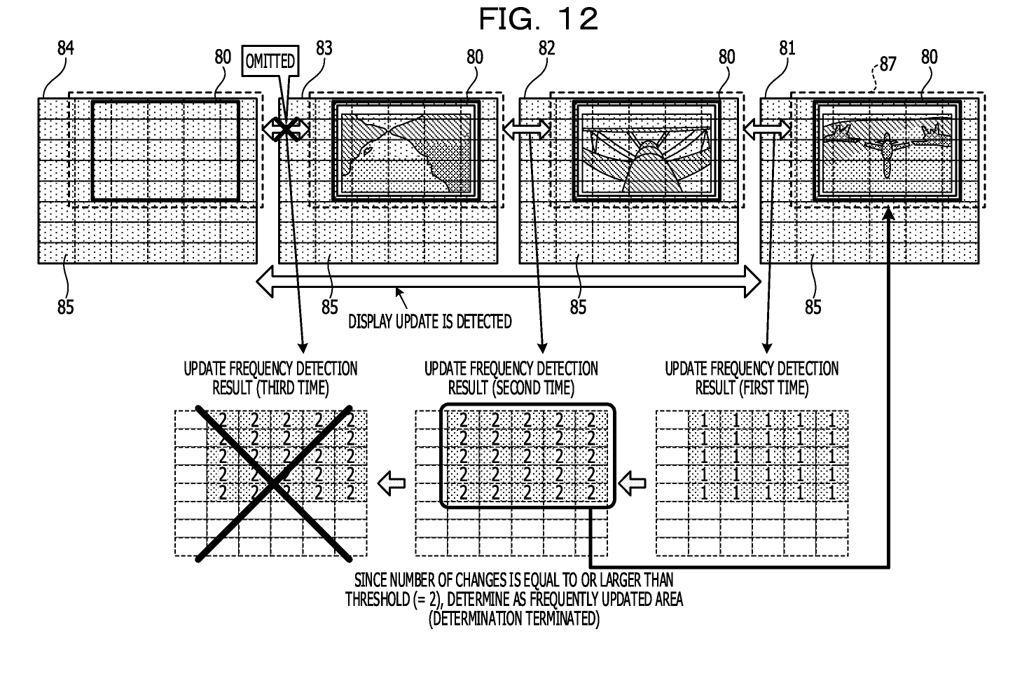

Hereinafter, an operation that the server 11 according to the second embodiment calculates a change frequency is described in detail. FIG. 12 is a diagram schematically illustrating an example flow of calculating a change frequency according to the second embodiment. In the example of FIG. 12, as similar to FIG. 7, a change frequency is calculated by sequentially comparing four images 81 to 84. It is to be noted that a threshold is “2”.

The calculation part 44 sequentially compares updated areas of the images 81 to 84 in the descending order in time series and counts up the number of changes of the updated area 80 for each of the divided areas, and terminates the comparison on the divided area whose number of changes is a threshold. In the example of FIG. 12, as a result of comparing the updated areas 80 of the image 81 and the image 82, since there is a change in all the divided areas in the updated area 80, the number of updates is counted up by 1. Also, as a result of comparing the updated areas 80 of the image 82 and the image 83, since there is a change in all the divided areas 85 in the updated area 80, the number of updates is counted up by 2. Here, the number of updates becomes the threshold of 2. Accordingly, comparing the updated areas 80 of the image 83 and the image 84 is omitted.

[Effects]

As described above, the server 11 according to the embodiment counts the number of changes as a change frequency for each of the divided areas in which an image is divided and terminates the comparison on the divided area whose number of changes is a predetermined threshold. Accordingly, the server 11 does not perform the comparison on the divided area whose change frequency is the predetermined threshold, so that the processing amount may be reduced.

### Third Embodiment

Hereinafter, a third embodiment is described. Described in the third embodiment is a case where setting information 32 is updated according to an available communication bandwidth.

[Server Configuration]

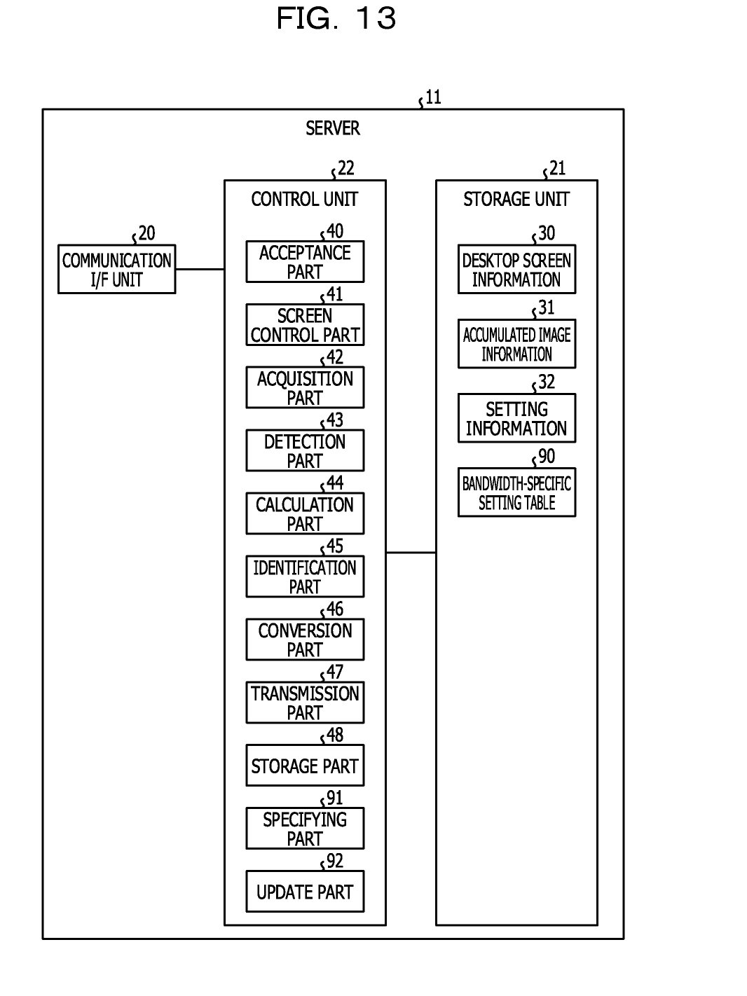

A server 11 according to the third embodiment is described. FIG. 13 is a diagram illustrating an example functional configuration of a server according to the third embodiment. It is to be noted that same reference numerals are given to denote portions same as those of the server according to the first embodiment as illustrated in FIG. 2, and different portions are mainly described.

A storage unit 21 of the server 11 illustrated in FIG. 13 stores a bandwidth-specific setting table 90. The bandwidth-specific setting table 90 stores an acquisition frequency to acquire an image and a threshold for each of the available communication bandwidths, which is set such that as the available communication bandwidth becomes lower, the acquisition frequency is larger and the threshold is smaller.

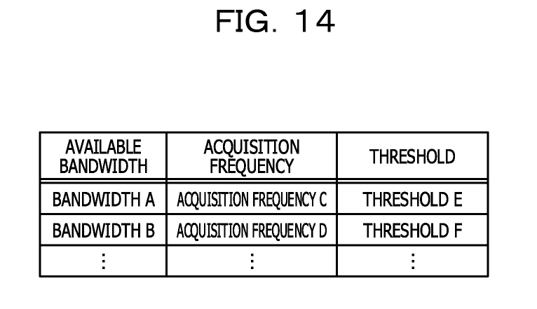

FIG. 14 is a diagram illustrating one example speed-specific setting information table. As illustrated in FIG. 14, the bandwidth-specific setting table 90 has items of “available bandwidth”, “acquisition frequency”, and “threshold”. The item of the available bandwidth is a field storing a communication bandwidth available for communications with client terminal 12. The item of the acquisition frequency is a field storing a frequency that the acquisition part 42 acquires image data of the desktop screen during transmission timing. The threshold is a field storing a threshold identifying an area whose change frequency is high.

In the example of FIG. 14, a bandwidth A has an acquisition frequency C and threshold E set therein. A bandwidth B has an acquisition frequency D and threshold F set therein. It is assumed in the example of FIG. 14 that the bandwidth A>the bandwidth B, the acquisition frequency C<the acquisition frequency D, and the threshold E>the threshold F. In other words, as an available communication bandwidth becomes lower, the acquisition frequency and the threshold are set larger.

Return to FIG. 13. A control unit 22 of the server 11 further includes a specifying part 91 and an update part 92.

The specifying part 91 specifies a communication bandwidth available for communications with the client terminal 12. For example, the specifying part 91 transmits a predetermined amount of data to the client terminal 12 at predetermined timing, and measures a transmission time used for transmitting the predetermined amount of data. Then, the specifying part 91 specifies an available communication bandwidth by dividing the transmitted data amount with transmission time. In this case, the available communication bandwidth indicates a communication speed. A method of specifying the available communication bandwidth is an example, and other method may be used.

The update part 92 is a processing unit to update setting information 32. For example, the update part 92 performs update so that a threshold becomes lower as the available communication bandwidth specified by the specifying part 91 becomes lower. Also, as the available communication bandwidth becomes lower, the update part 92 increases the acquisition frequency that the acquisition part 42 acquires an image between the images. For example, the update part 92 reads an acquisition frequency and threshold corresponding to the available communication bandwidth specified by the specifying part 91 from the bandwidth-specific setting table 90. Then, the update part 92 updates the acquisition frequency and the threshold which are stored in the setting information 32 with the read acquisition frequency and threshold. Accordingly, the setting information 32 acquires the image data of the desktop screen from the desktop screen information 30 with the updated frequency. Also, the identification part 45 identifies a frequently updated area from the divided areas whose number of changes is equal to or larger than the updated threshold.

[Operation of System]

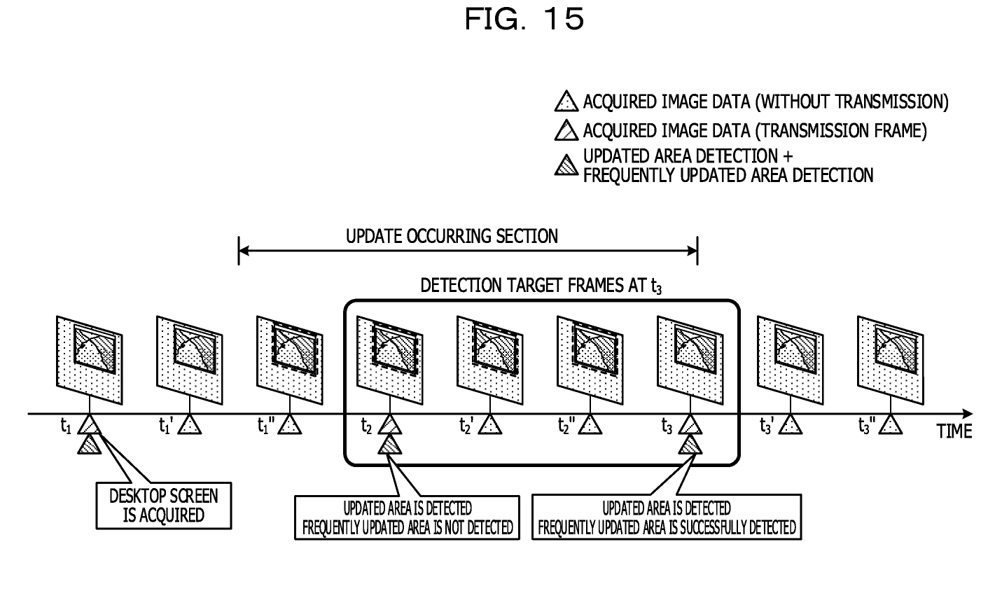

Hereinafter, described is an example operation that the server 11 according to the third embodiment detects a frequently updated area from an image of the desktop screen. FIG. 15 is a diagram schematically illustrating an example flow of detecting a frequently updated area. The example of FIG. 15 illustrates a case where an updated area is detected and then a frequently updated area is continuously detected. It is to be noted that a threshold is “3”. Also, it is assumed that an acquisition frequency to acquire an image between the images to be transmitted is “2”.

FIG. 15 illustrates images of the desktop screen at each time along the time course. The server 11 acquires the image data of the desktop screen from the desktop screen information 30 at the transmission timing corresponding to a transmission frame rate, and transmits the data relating to a virtual desktop to the client terminal 12. The images at time t₁, t₂, and t₃ are images in a transmission frame to be transmitted to the client terminal 12.

Also, the server 11 acquires the image data of the desktop screen from desktop screen information 30 even at the timing during the transmission timing. In the example of FIG. 15, two images are acquired during the transmission timing. In the example of FIG. 15, the image data of desktop screen is acquired at each of times t₁′, t₁″ between time t₁ and time t₂, times t₂′, t₂″ between time t₂ and time t₃, and times t₃′, t₃″ after time t₃. The images at times t₁′, t₁″, t₂′, t₂″, t₃′, and t₃″ are not transmitted to the client terminal 12.

It is assumed here in the example of FIG. 15 that a moving image is displayed on the desktop screen from time t₁″ and an area whose update frequency is high is generated. In the example of FIG. 15, times t₁, t₂, and t₃ are updated area detection timing. For example, the server 11 detects an updated area by comparing an image to be transmitted with an image having been transmitted one before the image to be transmitted. In this case, at the transmission timing of time t₂, the image includes a change as compared with the previous image but the number of changes is less than 3. Thus, a frequently updated area is not identified and the entire image is transmitted as a still image. Then, the frequently updated area is identified at the transmission timing of time t₃. In a case where the frequently updated area is transmitted as a still image when a communication bandwidth available between the server 11 and the client terminal 12 is narrow, a data amount increases and a delay is caused in displaying the image on the client terminal 12. This may deteriorate operability.

For this reason, the server 11 updates a threshold to be lower as the available communication bandwidth becomes lower. Also, the server 11 increases an acquisition frequency that the acquisition part 42 acquires an image between the images to be transmitted as the available communication bandwidth becomes lower. Accordingly, the server 11 quickly detects an area whose change frequency is high when the available communication bandwidth is low.

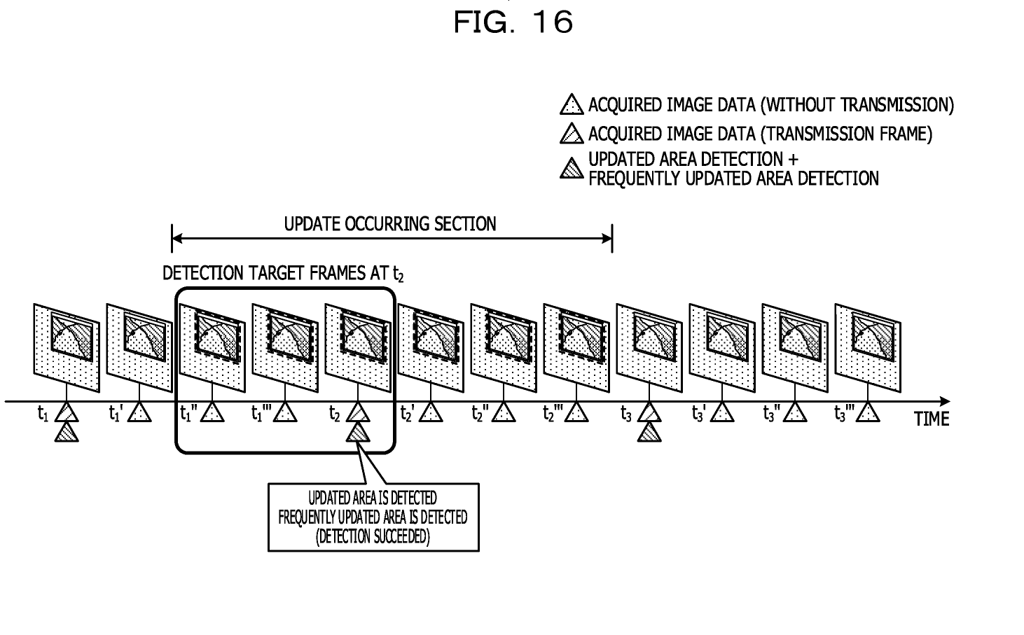

FIG. 16 is a diagram schematically illustrating an example flow of detecting a frequently updated area. The example of FIG. 16 illustrates the case where the threshold is updated to “2” and the acquisition frequency is updated to “3” in FIG. 15. In the example of FIG. 16, three images are acquired during the transmission timing. In the example of FIG. 16, image data of the desktop screen is acquired at each of times t₁′, t₁″, t₁′″ between time t₁ and time t₂, times t₂′, t₂″, t₂′″ between time t₂ and t₃, and t₃′, t₃″, t₃′″ after time t₃. The images of times t₁′, t₁″, t₁′″, t₂′, t₂″, t₂′″, and t₃′, t₃″, t₃′″ are not transmitted to the client terminal 12. It is assumed in the example of FIG. 16 that a moving image is displayed on the desktop screen from time t₁″ and an area with high update frequency is generated. In the example of FIG. 16, times t₁, t₂, t₃ are updated area detection timing. For example, the server 11 detects an updated area by comparing an image to be transmitted with an image having been transmitted one before the image to be transmitted. In this case, the number of changes at transmission timing of time t₂ becomes 2, as compared with the previous image, and it is equal to or larger than the updated threshold. Accordingly, a frequently updated area is identified and the frequently updated area is transmitted as a moving image.

[Processing Flow]

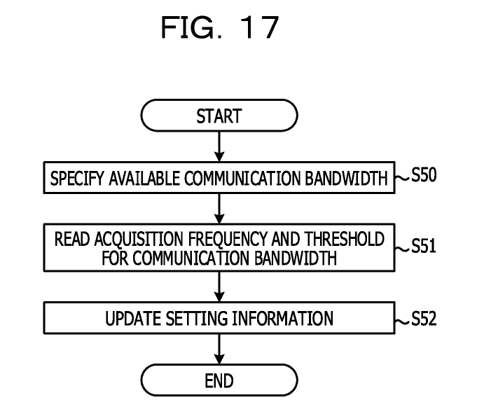

Hereinafter, described is a flow that the server 11 according to the third embodiment performs setting update processing to update setting information 32 according to an available communication bandwidth. FIG. 17 is a flowchart illustrating an example procedure of the setting update processing according to the third embodiment. This setting update processing is executed at predetermined timing, for example, timing for every predetermined time, such as date and time, or timing instructed by an administrator.

As illustrated in FIG. 17, a specifying part 91 specifies a communication bandwidth available for communications with the client terminal 12 (S50). An update part 92 reads an acquisition frequency and a threshold corresponding to the available communication bandwidth specified by the specifying part 91 from the bandwidth-specific setting table 90 (S51). Then, the update part 92 updates the acquisition frequency and the threshold, which are stored in the setting information 32, with the read acquisition frequency and threshold (S52) and terminates the processing.

[Effects]

As described above, the server 11 according to the embodiment specifies a communication bandwidth available for communications with the client terminal 12. Then, the server 11 performs any one or both of the update to lower a threshold and the update to increase the acquisition frequency to acquire an image between the images, as the specified available communication bandwidth becomes lower. Accordingly, the server 11 quickly detects an area with high change frequency when the available communication bandwidth is low.

### Fourth Embodiment

The embodiments related to the disclosed device are described above. The present disclosure may be implemented in various different modes other than the above-described embodiments. Hereinafter, other embodiment included in the present disclosure is described.

For example, described in the above embodiments is the case where the server 11 stores the image of the virtual desktop screen of the client terminal 12. The disclosed device is not limited to this. For example, the image of the virtual desktop screen may be stored in other server and may be acquired from other server.

Also, described in the above embodiments is the case where the image of the virtual desktop screen is transmitted to the client terminal 12. The disclosed device is not limited to this. For example, the image to be transmitted to the client terminal 12 is not limited to an image of the virtual desktop screen.

Also, described in the above embodiments is the case where an updated area is detected by comparing an image to be transmitted with an image in the previous transmission frame, but the disclosed device is not limited to this. For example, an updated area may be detected by comparing an image to be transmitted with an image in a predetermined transmission frame in two transmission frames before the image to be transmitted.

Also, described in the above embodiments is the case where the image data elapsed a predetermined period of time is deleted from the accumulated image information 31 and images for a predetermined period of time are accumulated in the accumulated image information 31, and all the accumulated images are read compared with one another, but the disclosed device is not limited to this. For example, image data for a predetermined or longer period of time may be accumulated in the accumulated image information 31 and the images may be read for the nearest predetermined period of time and be compared with one another. Also, a predetermined number of images may be accumulated in the accumulated image information 31 and all the accumulated images may be read and compared with one another.

In addition, components of the illustrated devices are functional and conceptual, and are not necessarily physically configured as illustrated. In other words, a specific state of dispersion and integration of the devices is not limited to the one illustrated, and all or one portion thereof may be configured by physically or functionally being dispersed or integrated in any unit according to various kinds of loads or usages. For example, processing parts of the server 11, such as a reception part 40, screen control part 41, acquisition part 42, detection part 43, calculation part 44, identification part 45, conversion part 46, transmission part 47, storage part 48, specifying part 91, and update part 92 may be integrated as appropriate. In addition, processing of each of the processing parts may be separated to processing of the multiple processing parts as appropriate. Also, one part or all of the devices and the processing parts may be integrated as appropriate. Furthermore, any one part or all of the processing functions performed in the processing parts may be achieved by the CPU and a program which is analyzed and executed by the CPU or may be achieved as a hardware by a wired logic.

[Change Detection Program]

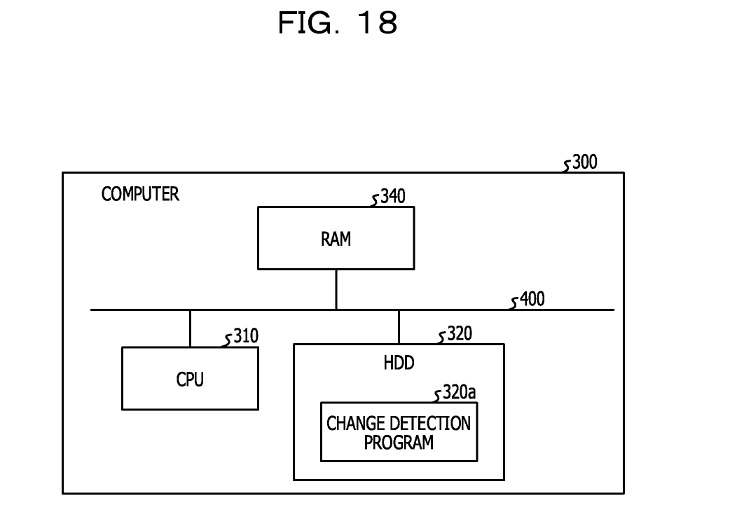

Moreover, the various kinds of processing described in the above embodiments may be achieved by executing a program prepared in advance in a computer system such as a personal computer or workstation. For this reason, described hereinafter is an example computer system which executes a program having similar functions as those of the above-described embodiments. FIG. 18 is a diagram illustrating a computer executing a change detection program.

As illustrated in FIG. 18, a computer 300 includes a central processing unit (CPU) 310, a hard disk drive (HDD) 320, and a random access memory (RAM) 340. These units 300 to 340 are connected with one another through a bus 400.

The HDD 320 has a change detection program 320a stored in advance to play a similar role as functions of the processing parts of the server 11. It is to be noted that the change detection program 320a may be separated as appropriate.

Also, the HDD 320 stores various pieces of information. For example, the HDD 320 stores various pieces of data which are used for the OS or processing.

Then, the CPU 310 reads and executes the change detection program 320a from the HDD 320 to execute a similar operation to those of the processing parts of the embodiments. In other words, the change detection program 320a executes similar operations to those of the processing parts of the client terminal 12 and the processing parts of the server 11.

It is to be noted that the change detection program 320a is not necessarily stored in the HDD 320 from the beginning.

For example, a program is stored in “potable physical medium” such as a flexible disk (FD), a CD-ROM, a DVD disk, a magneto-optical disk, or IC card, which is inserted into the computer 300. Then, the computer 300 may read a program therefrom and execute it.

Furthermore, a program is stored in “other computer (or server)” which is connected with the computer 300 through a public line, the Internet, LAN, or WAN. Then, the computer 300 may read a program therefrom and execute it.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing device comprising:
a processor; and
a memory which stores a plurality of instructions, which when executed by the processor, cause the processor to execute:
transmitting a created image to a client terminal;
acquiring at least one image created at timing different from image transmission timing by the transmitting; and
calculating a change frequency, based on the transmitted image by the transmitting and the image acquired by the acquiring, for each of multiple divided areas constituting an image.

2. The device according to claim 1, further comprising:
detecting, as an updated area, an area with a change among the multiple divided areas by comparing an image to be transmitted by the transmitting with an image having been transmitted before the image,
wherein the calculating is calculating a change frequency by sequentially comparing the updated areas of the transmitted image and the image acquired by the acquiring in descending order in time series from the image in which the updated area is detected by the detecting.

3. The device according to claim 2,
wherein the calculating is counting up the number of changes as the change frequency for each of the divided areas and terminating the comparison on a divided area where number of changes reaches a predetermined threshold.

4. The device according to claim 2, further comprising:
converting image data of the updated area such that, in the updated area, an area whose change frequency calculated by the calculation unit is equal to or larger than a predetermined threshold is treated as a moving image area, while the other area is treated as a still image area,
wherein the transmitting transmits image data converted by the converting.

5. The device according to claim 4, further comprising:
specifying a communication bandwidth available for communications with the client terminal; and
performing any one or both of update to lower the threshold and update to increase an acquisition frequency to acquire an image between the transmitted images in the acquiring, as the available communication bandwidth specified by the specifying becomes lower.

6. An information processing method, comprising:
transmitting a created image to a client terminal;
acquiring, by a computer processor, at least one image created at timing different from image transmission timing by the transmitting; and
calculating a change frequency, based on the transmitted image by the transmitting and the image acquired by the acquiring, for each of multiple divided areas constituting an image.

7. The method according to claim 6, further comprising:
detecting, as an updated area, an area with a change among the multiple divided areas by comparing an image to be transmitted by the transmitting with an image having been transmitted before the image,
wherein the calculating is calculating a change frequency by sequentially comparing the updated areas of the transmitted image and the image acquired by the acquiring in descending order in time series from the image in which the updated area is detected by the detecting.

8. The method according to claim 7,
wherein the calculating is counting up the number of changes as the change frequency for each of the divided areas and terminating the comparison on a divided area where number of changes reaches a predetermined threshold.

9. The method according to claim 7, further comprising:
converting image data of the updated area such that, in the updated area, an area whose change frequency calculated by the calculation unit is equal to or larger than a predetermined threshold is treated as a moving image area, while the other area is treated as a still image area,
wherein the transmitting transmits image data converted by the converting.

10. The method according to claim 9, further comprising:
specifying a communication bandwidth available for communications with the client terminal; and
performing any one or both of update to lower the threshold and update to increase an acquisition frequency to acquire an image between the transmitted images in the acquiring, as the available communication bandwidth specified by the specifying becomes lower.

11. A computer-readable non-transitory storage medium storing an information processing program that causes a computer to execute a process comprising:
transmitting a created image to a client terminal;
acquiring at least one image created at timing different from image transmission timing by the transmitting; and
calculating a change frequency, based on the transmitted image by the transmitting and the image acquired by the acquiring, for each of multiple divided areas constituting an image.

12. The computer-readable non-transitory storage medium according to claim 11, further comprising:
detecting, as an updated area, an area with a change among the multiple divided areas by comparing an image to be transmitted by the transmitting with an image having been transmitted before the image,
wherein the calculating is calculating a change frequency by sequentially comparing the updated areas of the transmitted image and the image acquired by the acquiring in descending order in time series from the image in which the updated area is detected by the detecting.

13. The computer-readable non-transitory storage medium according to claim 12,
wherein the calculating is counting up the number of changes as the change frequency for each of the divided areas and terminating the comparison on a divided area where number of changes reaches a predetermined threshold.

14. The computer-readable non-transitory storage medium according to claim 12, further comprising:
converting image data of the updated area such that, in the updated area, an area whose change frequency calculated by the calculation unit is equal to or larger than a predetermined threshold is treated as a moving image area, while the other area is treated as a still image area,
wherein the transmitting transmits image data converted by the converting.

15. The computer-readable non-transitory storage medium according to claim 14 further comprising:
specifying a communication bandwidth available for communications with the client terminal; and
performing any one or both of update to lower the threshold and update to increase an acquisition frequency to acquire an image between the transmitted images in the acquiring, as the available communication bandwidth specified by the specifying becomes lower.
